(19) United States
(12) Patent Application Publication
(10) Pub. No.: US 2014/0195361 A1
(43) Pub. Date: Jul. 10, 2014

(54) METHOD AND SYSTEM FOR ACTIVE RECEIPT MANAGEMENT

(71) Applicants: Kaitlin Murphy, Hillsboro, OR (US); Gyan Prakash, Beaverton, OR (US)

(72) Inventors: Kaitlin Murphy, Hillsboro, OR (US); Gyan Prakash, Beaverton, OR (US)

(21) Appl. No.: 13/997,684

(22) PCT Filed: Dec. 31, 2011
(86) PCT No.: PCT/US11/68279

§ 371 Date: Mar. 19, 2014

(51) Int. Cl. G06Q 20/20; G06Q 20/04

(52) U.S. Cl. CPC G06Q 20/202; G06Q 20/0453
USPC 705/21

(57) ABSTRACT

A method and device for managing and storing a plurality of electronic receipts includes receiving transaction data corresponding to a product purchased during a purchase transaction with an electronic receipt server. The electronic receipt server may parse the transaction data to retrieve information describing an aspect or a detail of the purchased product or the purchase transaction. The retrieved information may be stored in storage of the electronic receipt server as an electronic receipt. One or more electronic receipts of a plurality of electronic receipts stored in the electronic receipt server may be accessed and managed from an application executing on a computing device or a mobile computing device.

### BACKGROUND

An increasing number of consumers purchase goods and services from a variety of retailers. For example, a consumer may purchase goods and services from a traditional, brick-and-mortar retailer, or they may purchase goods and services over the Internet through an on-line retailer. Additionally, consumers may purchase such goods and services using any number of payment methods. For instance, it is not uncommon for a consumer to pay for one product using cash and another product using a credit card or a gift card.

Typically, at the completion of a purchase transaction, the retailer provides the consumer with a physical record or receipt memorializing the details of the transaction. Many times, however, one receipt generated by one retailer is in a different format than a receipt generated by another retailer. Therefore, the average consumer must typically manage a large number of receipts from a variety of retailers for various goods or services purchased using any number of payment methods. Managing such disparate information can be cumbersome and time-consuming for a consumer.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of at least one embodiment of a system for storing and managing electronic receipts;

FIG. 2 is a simplified block diagram of at least one embodiment of a software environment of the electronic receipt server or FIG. 1;

FIG. 3 is a simplified flow diagram of at least one embodiment of a method for receiving a new electronic receipt with the electronic receipt server of FIGS. 1 and 2;

FIG. 4 is a simplified flow diagram of at least one embodiment of a method for generating and transmitting a new electronic receipt with the point-of-sale terminal of FIG. 1;

FIG. 5 is a simplified flow diagram of at least one embodiment of a method for forwarding a new electronic receipt to the electronic receipt server of FIGS. 1 and 2 using a mobile computing device as a proxy; and

FIG. 6 is a simplified flow diagram of at least one embodiment of a method for managing electronic receipts stored on the electronic receipt server of FIGS. 1 and 2.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is with the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on one or more machine-readable media, which may be read and executed by one or more processors. A machine-readable medium may be embodied as any device or physical structure for storing or transmitting information in a form readable by a machine (e.g., a computing device). For example, a machine-readable medium may be embodied as any one or combination of read only memory (ROM); random access memory (RAM); magnetic disk storage media; optical storage media; flash memory devices; and others.

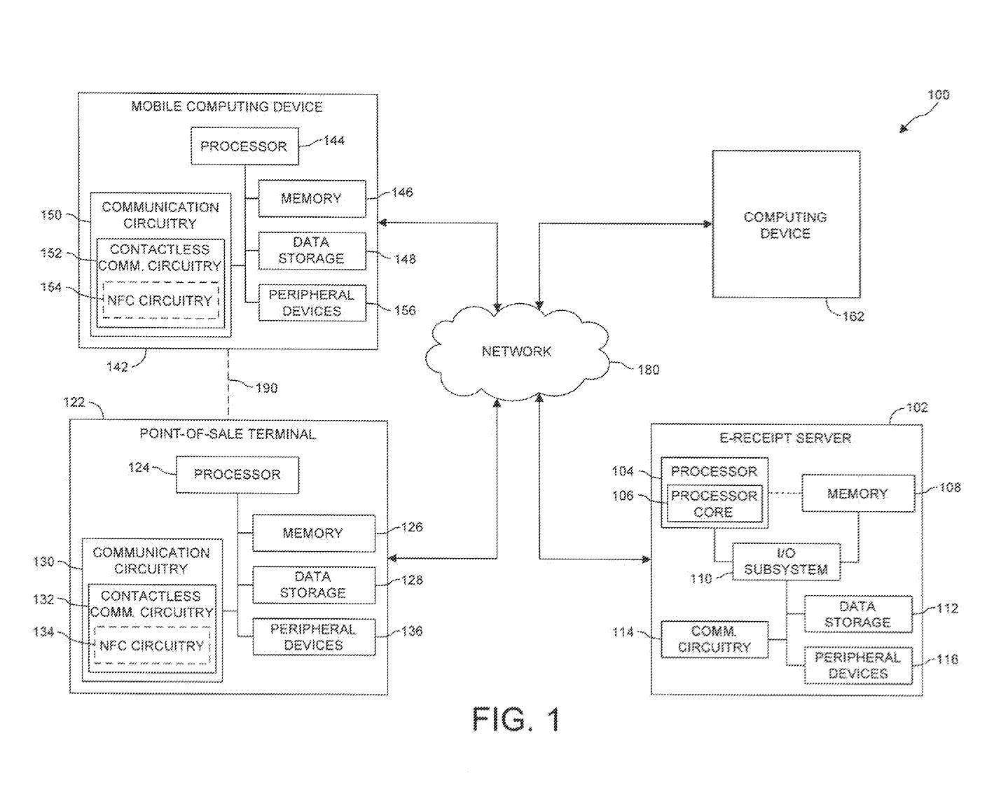

Referring now to FIG. 1, a system 100 for managing electronic receipts includes an electronic receipt server (“e-receipt server”) 102 configured to store and manage one or more electronic receipts corresponding to one or more transactions (i.e., purchasing goods or services, returning goods or cancelling services, refilling prescriptions, etc.), a point-of sale terminal 122 configured to generate and transmit an electronic receipt to the e-receipt server 102, and a mobile computing device 142 configured to remotely manage the one or more electronic receipts on the e-receipt server 102. In some embodiments, the system 100 may also include a computing device 162 configured to remotely manage the one or more electronic receipts stored on the e-receipt server 102. To do so, as discussed in more detail below, the e-receipt server 102 receives an electronic receipt generated by the point-of-sale terminal 122 corresponding to a transaction. The electronic receipt may be received by the e-receipt server 102 over a network 180 (e.g., the Internet, a private network, a public network, etc.) and stored in a database on the e-receipt server 102. In some embodiments, the e-receipt server 102 may receive the electronic receipt from the mobile computing device 142 acting as a proxy between the point-of-sale terminal 122 and the e-receipt server 102. In operation, the e-receipt server 102 may store a plurality of electronic receipts, each electronic receipt corresponding to a different transaction and/or a different user. To facilitate organization and storage of the electronic receipts, the e-receipt server 102 stores each electronic receipt (or a portion of the information contained therein) in a database according to a unique identifier assigned to each user of the system 100. As such, upon receiving a new electronic receipt corresponding to a transaction, the e-receipt server 102 parses the electronic receipt and determines the unique user identifier associated with the user engaged in the transaction. The e-receipt server 102 may then categorize and store information corresponding to the new electronic receipt in the database as a function of the determined unique user identifier. Once the e-receipt server 102 has categorized and stored information corresponding to the new electronic receipt in the database, the user may manage the new electronic receipt using the mobile computing device 142 and/or the computing device 162.

It should be understood that although the e-receipt server 102 in the illustrative embodiment of FIG. 1 is configured to manage and store a plurality of electronic receipts corresponding to one or more transactions, the e-receipt server 102 may also be configured to store and manage other types of information. Additionally, in some embodiments, the e-receipt server 102 may be configured, additionally or alternatively, to manage and store other forms of content associated with a particular transaction. For example, in addition to storing and managing an electronic receipt corresponding to a product purchased by the user, the e-receipt server 102 may also store and manage an image of the purchased product or an electronic copy of the user's manual. In such embodiments, the e-receipt server 102 may receive and/or retrieve the other forms of content associated with the particular transaction. Thereafter, the e-receipt server 102 may store and/or link the other forms of content with the electronic receipt stored in the database.

The e-receipt server 102 may be embodied as any type of computing device capable of performing the functions described herein. For example, the e-receipt server 102 may be embodied as a stand-alone server (i.e. rack, tower, mini, etc.), a distributed server, a supercomputer, a mainframe, or any other computing device capable of performing the functions described herein.

In the illustrative embodiment of FIG. 1, the e-receipt server 102 includes a processor 104, an I/O subsystem 110, a memory 108, a data storage device 112, and one or more peripheral devices 116. In some embodiments, several of the foregoing components may be incorporated on a motherboard of the e-receipt server 102, while other components may be communicatively coupled to the motherboard via, for example, a peripheral port. Furthermore, it should be appreciated that the e-receipt server 102 may include other components, sub-components, and devices commonly found a server and/or computing device, which are not illustrated in FIG. 1 for clarity of the description.

The processor 104 of the e-receipt server 102 may be embodied as any type of processor capable of executing software/firmware, such as a microprocessor, digital signal processor, microcontroller, or the like. The processor 104 is illustratively embodied as a single core processor having a processor core 106. However, in other embodiments, the processor 104 may be embodied as a multi-core processor having multiple processor cores 106. Additionally, the e-receipt server 102 may include additional processors 104 having one or more processor cores 106.

The I/O subsystem 110 of the e-receipt server 102 may be embodied as circuitry and/or components to facilitate input/output operations with the processor 104 and/or other components of the e-receipt server 102. In some embodiments, the I/O subsystem 110 may be embodied as a memory controller hub (MCH or “northbridge”), an input/output controller hub (ICH or “southbridge”), and a firmware device. In such embodiments, the firmware device of the I/O subsystem 110 may be embodied as a memory device for storing Basic Input/Output System (BIOS) data and/or instructions and/or other information (e.g., a BIOS driver used during booting of the e-receipt server 102). However, in other embodiments, I/O subsystems having other configurations may be used. For example, in some embodiments, the I/O subsystem 110 may be embodied as a platform controller huh (PCH). In such embodiments the memory controller hub (MCH) may be incorporated in or otherwise associated with the processor 104, and the processor 104 may communicate directly with the memory 108 (as shown by the hashed line in FIG. 1). Additionally, in other embodiments, the I/O subsystem 110 may form a portion of a system-on-a-chip (SoC) and be incorporated, along with the processor 104 and other components of the e-receipt server 102, on a single integrated circuit chip.

The processor 104 is communicatively coupled to the I/O subsystem 110 via a number of signal paths. These signal paths (and other signal path illustrated in FIG. 1) may be embodied as any type of signal paths capable of facilitating communication between the components of the e-receipt server 102. For example, the signal paths may be embodied as any number of point-to-point links, wires, cables, light guides, printed circuit board traces, via, bus, link, interconnect, intervening devices, and/or the like.

The memory 108 or the e-receipt server 102 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 108 is communicatively coupled to the I/O subsystem 110 via a number of signal paths. Various data and software may be stored in the memory device 108. For example, one or more operating systems, applications, programs, libraries, and drivers that make up the software stack executed by the processor 104 may reside in memory 108 during execution. Furthermore, software and data stored in memory 108 may be swapped between the memory 108 and the data storage device 112 as part of memory management operations. Although only one memory device 108 is illustrated in FIG. 1, the e-receipt server 102 may include any number of additional memory devices in other embodiments.

The data storage device(s) 112 of the e-receipt server 102 may be embodied as any type of device or devices configured for the short-term or long-term storage of data such as for example, memory devices and circuits, memory cards, hard disk drives, micro hard disk drives, solid-state drives, or other data storage devices. In some embodiments, the data storage device(s) 112 may be used to store information corresponding to one or more electronic receipts generated during a transaction.

Additionally, the e-receipt server 102 may include communication circuitry 114 to facilitate communication with one or more remote computing devices over a network 180. The e-receipt server 102 may use any suitable communication protocol to communicate with other computing devices over the network 180 depending on, for example, the particular type of network(s) 180. For example, in some embodiments, the e-receipt server 102 may communicate with one or more of the point-of-sale terminal 122, the mobile computing device 142, and the computing device 162 over the network 180.

The peripheral devices 116 of the e-receipt server 102 may include any number of peripheral or interface devices. For example, the peripheral devices 116 may include a display, a touch screen, a keyboard, a mouse, external speakers, and/or other peripheral devices. The peripheral devices 116 are communicatively coupled to the I/O subsystem 110 via a number of signal paths thereby allowing the I/O subsystem 110 and/or processor 104 to receive inputs from and send outputs to the peripheral devices 116. The particular devices included in the peripheral devices 116 may depend upon, for example, the intended use of the e-receipt server 102.

The point-of-sale terminal 122 may be embodied as any type of computing device capable of conducting a sales transaction and performing the other functions described herein. For example, the point-of-sale terminal 122 may be a retail or wholesale computer, which may be embodied as a desktop computer, a laptop computer, a tablet computer, a mobile internet device, a handheld computer, a smart phone, a personal digital assistant, a telephony device, or other computing device. In the illustrative embodiment of FIG. 1, the point-of-sale terminal 122 includes components similar to the e-receipt server 102 such as a processor 124, a memory 126, a data storage device 128, and one or more peripheral devices 136. In some embodiments, the point-of-sale terminal 122 may include an I/O subsystem similar to the I/O subsystem 110 of the e-receipt server 102. In some embodiments, several of the foregoing components may be incorporated on a motherboard of the point-of-sale terminal 122, while other components may be communicatively coupled to the motherboard via, for example, a peripheral port. Furthermore, it should be appreciated that the point-of-sale terminal 122 may include other components, sub-components, and devices commonly found in a computer and/or computing device, which are not illustrated in FIG. 1 for clarity of the description.

The processor 124 of the point-of-sale terminal 122 may be embodied as any type of processor capable of executing software/firmware, such as a microprocessor, digital signal processor, microcontroller, or the like. The processor 124 is illustratively embodied as a single core processor having a processor core. However, in other embodiments, the processor 124 may be embodied as a multi-core processor having multiple processor cores. Additionally, the point-of-sale terminal 122 may include additional processors 124 having one or more processor cores.

The processor 124 is communicatively coupled to the components of the point-of-sale terminal 122 via a number of signal paths. These signal paths (and other signal paths illustrated in FIG. 1) may be embodied as any type of signal paths capable of facilitating communication between the components of the point-of-sale terminal 122. For example, the signal paths may be embodied as any number of wires, cables, light guides, printed circuit board traces, via, bus, link, interconnect, intervening devices, and/or the like.

The memory 126 of the point-of-sale terminal 122 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 126 is communicatively coupled to other components of the point-of-sale terminal 122 via a number of signal paths. Various data and software may be stored in the memory device 126. For example, one or more operating systems, applications, programs, libraries, and drivers that make up the software stack executed by the processor 124 may reside in memory 126 during execution. Furthermore, software and data stored in memory 126 may be swapped between the memory 126 and the data storage device 128 as part of memory management operations. Although only one memory device 126 is illustrated in FIG. 1, the point-of-sale terminal 122 may include any number of additional memory devices in other embodiments.

The data storage device(s) 128 of the point-of-sale terminal 122 may be embodied as any type of device or devices configured for the short-term or long-term storage of data such as, for example, memory devices and circuits, memory cards, hard disk drives, micro hard disk drives, solid-state drives, or other data storage devices. In some embodiments, the data storage device(s) 128 may be used to store information corresponding to one or more electronic receipts generated during a transaction.

Additionally, point-of-sale terminal 122 may include communication circuitry 130 to facilitate communication with one or more remote computing devices over the network 180. The point-of-sale terminal 122 may use any suitable communication protocol to communicate with other computing devices over the network 180 depending on, for example, the particular type of network(s) 180. For example, in some embodiments, the point-of-sale terminal 122 may communicate with one or more of the e-receipt server 102, the mobile computing device 142, and the computing device 162 over the network 180.

In some embodiments, the communication circuitry 130 of the point-of-sale terminal 122 includes a contactless communication mechanism 132. In such embodiments, the point-of-sale terminal 122 may use the contactless communication mechanism 132, such as the near-field communication (NFC) circuitry 134, to transmit and/or receive data to/from one or more remote computing devices without using the network 180. For example, the point-of-sale terminal 122 may use NFC data exchanges 190 to transfer data to/from the mobile computing device 142, which as discussed below, may also include NFC circuitry. It should be understood that although the contactless communication circuitry 132 of the point-of-sale terminal 122 is embodied as the NFC circuitry 134 in the illustrative embodiment, the contactless communication circuitry 132 may be embodied as, or otherwise include, other types of contactless communication mechanisms for transferring data to/from the mobile computing device 142 in other embodiments. For example, the contactless communication circuitry 132 of the point-of-sale terminal 122 may be embodied as Bluetooth® circuitry or any other short-range communication circuitry suitable for use in communicating with the mobile computing device 142.

The peripheral devices 136 of the point-of-sale terminal 122 may include any number of peripheral or interface devices. For example, the peripheral devices 136 may include a display, a touch screen, a keyboard, a mouse, external speakers, and/or other peripheral devices. The peripheral devices 136 are communicatively coupled to the I/O subsystem via a number of signal paths thereby allowing the I/O subsystem and/or processor 124 to receive inputs from and send outputs to the peripheral devices 136. The particular devices included in the peripheral devices 136 may depend upon, or example, the intended use of the point-of-sale terminal 122.

The mobile computing device 142 may be embodied as any type of portable device capable of performing the management and/or proxy functions described below. Similar to the receipt server 102 and the point-of-sale terminal 122, the mobile computing device 142 may include various components typically found in a computing device. In the illustrative embodiment of FIG. 1, the mobile computing device 142 includes a processor 144, a memory 146, a data storage device 148, communication circuitry 150, and one or more peripheral devices 156. As such, the mobile computing device 142 may include components similar to those described above in relation to the e-receipt server 102 and/or the point-of-sale terminal 122.

In some embodiments, the communication circuitry 150 of the mobile computing device 142 includes a contactless communication mechanism 152. In such embodiments, the mobile computing device 142 may use the contactless communication mechanism 152, such as the near-field communication (NFC) circuitry 154, to transmit and/or receive data to/from one or more remote computing devices without using the network 180. For example, the mobile computing device 142 may use NFC data exchanges 190 to transfer data to/from the point-of-sale terminal 122, which as discussed above, may also include NFC circuitry. It should be understood that although the contactless communication circuitry 152 of the mobile computing device 142 is embodied as the NFC circuitry 154 in the illustrative embodiment, the contactless communication circuitry 152 may be embodied as, or otherwise include, other types of contactless communication mechanisms for transferring data to/from the point-of-sale terminal 122 in other embodiments. For example, the contactless communication circuitry 152 of the mobile computing device 142 may be embodied as Bluetooth® circuitry or any other short-range communication circuitry suitable for use in communicating with the point-of-sale terminal 122.

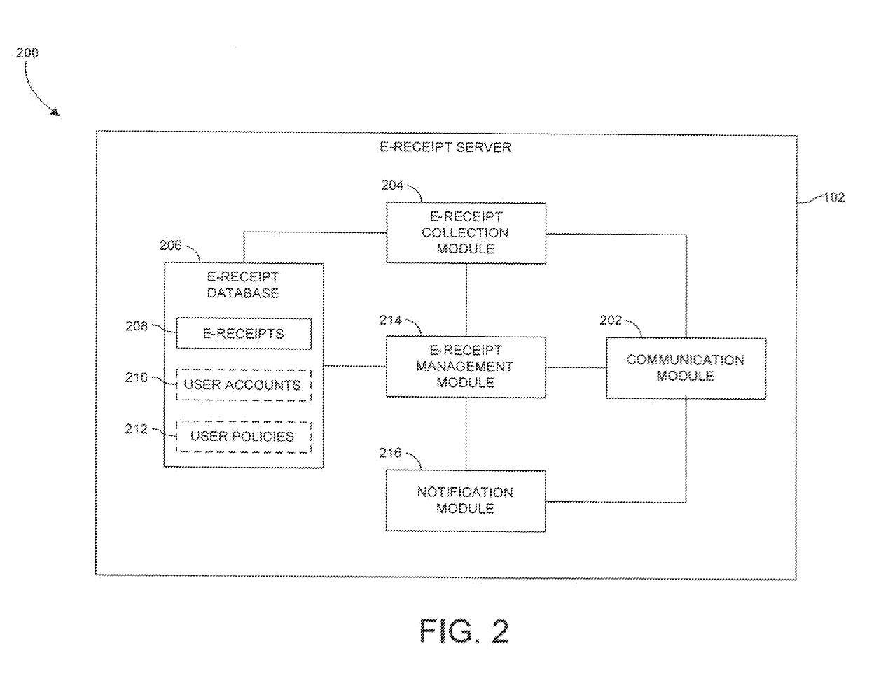

Referring now to FIG. 2, one embodiment of a software environment 200 of the e-receipt server 102 includes a communication module 202, an electronic receipt collection module 204, an electronic receipt database 206, an electronic receipt management module 214, and a notification module 216. Each of the modules 202, 204, 214, 216 may be embodied as software/firmware and associated hardware (e.g., logical units). Of course, it should be appreciated that the e-receipt server 102 may include other components, sub-components, modules, and devices commonly found in a server and/or computing device, which are not illustrated in FIG. 2 for clarity of the description.

As discussed above, the e-receipt server 102 is configured to store and manage one or more electronic receipts corresponding to one or more transactions. Transactions may include a purchase transaction (i.e., the purchase of goods or services), a return transaction (i.e., the return or cancellation of goods or services), a prescription refill transaction (i.e., the refill of an prescription), and any other type of transaction that may be documented for historical preservation and/or record keeping. As discussed above, each electronic receipt may correspond to a different transaction and may include electronic information describing one or more aspects or details of the transaction. For example, in some embodiments, an electronic receipt may include electronic information corresponding to the date that a product or service was purchased, the description of the product or service purchased, the price of the product or service, the name of the merchant, the location from which the product or service was purchased, the technical specifications of the product or service, the warranty information associated with the product or service, the return policy of the merchant, and any other information describing the details of a transaction. Additionally, the electronic receipt may include other forms of content associated with a particular transaction or product. For example, in some embodiments, the electronic receipt may include an image of the products or services purchased, recall information associated with the products or services purchased, an electronic version (i.e., a Portable Document Format (PDF) file, an e-book, a web page, etc.) of a user's manual, audio files, video files, and any other form of content describing an aspect of the product or service or the transaction itself.

In use, the communication module 202 facilitates communications with one or more of the point-of-sale terminal 122, the mobile computing device 142, and the computing device 162. In some embodiments, the communication module 202 receives one or more electronic receipts from the point-of-sale terminal 122 over the network 180. The communication module may also receive one or more electronic receipts from the point-of-sale terminal 122 using the mobile computing device 142 as a proxy device. To do so, the communication module 202 may communicate with the mobile computing device 142 over the network 180 and receive an electronic receipt that was first transferred to the mobile computing device 142 from the point-of-sale terminal 122 via on or more NFC data exchanges 190 or other form of short-range communications.

The electronic receipt collection module 204 is communicatively coupled to the communication module 202 and facilities storing a newly received electronic receipt corresponding to a transaction on the e-receipt server 102. In some embodiments, the electronic receipt collection module 204 parses the one or more electronic receipts and stores the parsed information in one or more tables of the electronic receipt database 206. To do so, the electronic receipt collection module 204 may parse an electronic receipt having a predefined or a reference format. For example, the electronic receipt in some embodiments may comprise an Extensible Markup Language (XML) document having one or more XML elements describing information associated with a transaction. In such embodiments, the electronic receipt collection module 204 may include an XML parser or some other mechanism for extracting information associated with the transaction from the XML document.

It should be understood that although the electronic receipt is described as being embodied as an XML document having XML elements in the illustrative embodiment, the electronic receipt may be embodied as a document or file having a different format in other embodiments. For example, the electronic receipt may be embodied as a comma-separated value (CSV) file, a text file, an encrypted data file, or any other format suitable to electronically embody information describing one or more aspects of a transaction. In other embodiments, the electronic receipt may also be embodied as an image file corresponding to a physical receipt generated during a transaction. In such embodiments, the image file may include metadata stored internally or externally to the image file. The metadata of the image file may contain the information associated with the transaction. In embodiments wherein the electronic receipt is embodied as a document or file having a different format other than an XML document, the electronic receipt collection module 204 includes a suitable mechanism for parsing and storing the information from the electronic receipt in the electronic receipt database 206.

The electronic receipt database 206 may be stored in the data storage device 112 of the e-receipt server 102. The electronic receipt database 206 is configured to store one or more electronic receipts associated with one or more transactions. The electronic receipt database 206 may be embodied as or otherwise include one or more tables to store the electronic receipt information associated with each electronic receipt documenting a transaction. In the illustrative embodiment, the electronic receipt database 206 includes an electronic receipts table 208 to store the electronic receipt information associated with each electronic receipt. For example, the electronic receipt database 206 may store electronic receipt information associated with one or more transactions to purchase goods or services, return or cancel goods or services, refill prescriptions, and any other type of transaction that may be documented for historical preservation and/or record keeping. Additionally, in some embodiments, the electronic receipt database 206 may include a user accounts table 210 and/or a user policies table 212.

The user accounts table 210 of the electronic receipt database 206 may include information associated with each user of the e-receipt server 102. For example, the user accounts table 210 includes information (i.e., a user identifier) to uniquely identify each user. The user identifier can be any type of information that uniquely identifies a user. In some embodiments, the user identifier is embodied as a unique e-mail address assigned to the user. The unique e-mail address may be linked or otherwise associated with a personal e-mail address supplied by the user. In other embodiments, the user identifier may be embodied as a unique username either assigned to the user or chosen by the user during a registration process. In use, the user accounts table 210 may be used by the electronic receipt collection module 204 to identify a particular user and/or facilitate storing information parsed from a newly received electronic receipt in the electronic receipts table 208 as a function of the user identifier.

The user policies table 212 of the electronic receipt database 206 may include one or more policies defined by a user of the e-receipt server 102 to specify preferences or rules corresponding to the storage and management of electronic receipts. For example, the user policies table 212 may include rules specifying how newly received electronic receipts should be categorized on the e-receipt server 102, rules defining an alert or notification to be provided to the user if a certain event occurs or a threshold level is reached, rules defining other users that may access one or more electronic receipts corresponding to the user, and any other type of rule or preference suitable for managing and storing electronic receipts.

The electronic receipt management module 214 facilitates management of the e-receipt server 102 by the user. Additionally or alternatively, the electronic receipt management module 214 may facilitate viewing one or more of the electronic receipts stored in the electronic receipt database 206. To do so, the electronic receipt management module 214 may generate a user interface (UI) or otherwise provide remote management and/or viewing functionality. For example, the electronic receipt management module 214 may retrieve one or more receipts associated with the user from the electronic receipt database 206 as a function of the unique identifier assigned to the user. In some embodiments, the electronic receipt management module 214 generates one or more web pages, which when accessed by a web browser executing on the computing device 162 or the mobile computing device 142, enable the user to create and/or modify one or more settings or policies on the e-receipt server 102. Additionally, the electronic receipt management module 214 may generate one or more web pages, which when accessed by the user, provide information associated with one or more electronic receipts formatted according to a user policy stored in user policies table 212. It should be understood that although the electronic receipt management module 214 generates one or web pages in the illustrative embodiment to provide remote management and/or viewing of electronic receipts stored on the e-receipt server 102, the electronic receipt management module 214 may provide other mechanisms for remotely managing and/or viewing electronic receipts in other embodiments. For example, in some embodiments, the electronic receipt management module 214 may facilitate communications with one or more applications executing on the mobile computing device 142 or the computing device 162. To do so, the electronic receipt management module 214 may perform one or more management functions in response to receiving commands generated by the one or more applications running on the mobile computing device 142 and/or the computing device 162.

The notification module 216 may generate one or more alerts and/or notifications to be provided to the user. In use, the notification module 216 may generate an alert and/or notification according to one or more of the user policies stored in the user policies table 212. For example, the user policies table 212 may include a policy defining a rule indicating the user should be alerted if a user-defined threshold setting a maximum amount of money that can be spent on a product or category of products has been reached during a specified time period. The notification module 216 may monitor the electronic receipts table 208 and determine whether the user-defined threshold set by the user in the policy has been reached. To do so, the notification module may aggregate one or more electronic receipts associated with the user to determine an aggregate amount of money spent for a given product or category of products.

In response to determining that the user-defined threshold has been reached, the notification module 216 may generate an alert and/or notification to be sent to the user using the communication module 202 via, for example, an e-mail message to the user, a Short Message Service (SMS) text to the mobile computing device 142 (i.e., a mobile phone, a smart phone, a tablet computer, etc.) of the user, and any other suitable mechanism for alerting and/or notifying the user. Additionally or alternatively, the notification module 216 may generate one or more alerts and/or notifications in response to determining that the communication module 202 has received a new electronic receipt and that the electronic receipt collection module 204 has stored the newly received electronic receipt in the electronic receipt database 206. Yet further, in some embodiments, the notification module 216 may generate reminders for particular due dates or services based on e-receipt information (e.g., the purchase date of product). For example, the notification module 216 may be configured to determine reminder data (e.g., “prescription refill due”) and a reminder date based on the e-receipt information and generate a reminder alert or notification of the reminder data on the reminder date. Such reminder alert may include for example, a notification for the refill of prescriptions, the renewal of insurance policies, the scheduling of routine home or auto maintenance, or any other service requiring periodic scheduling.

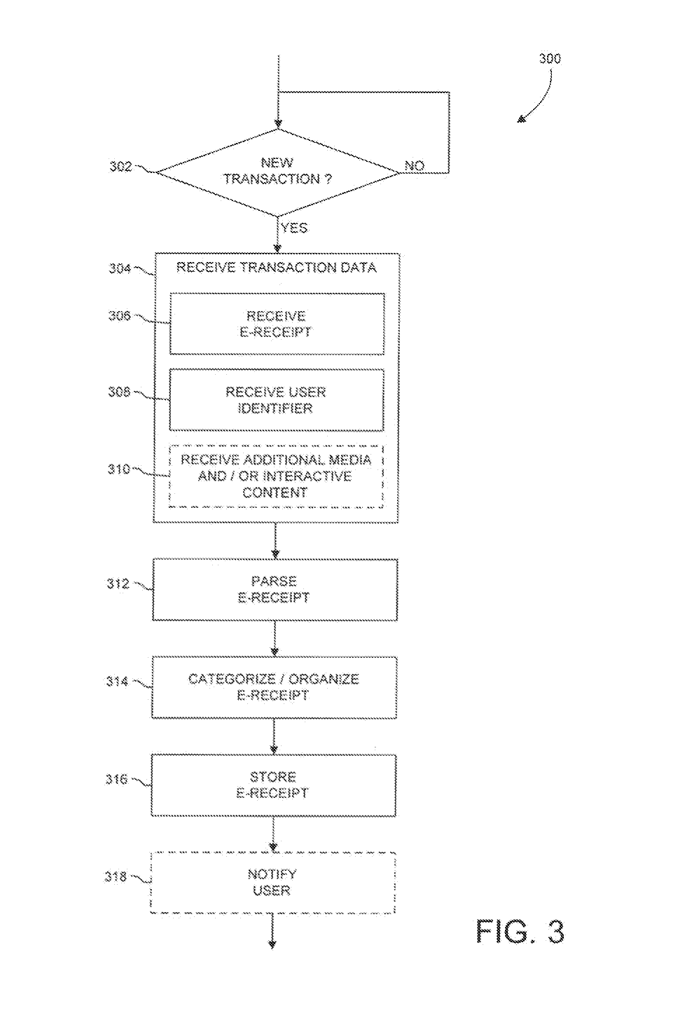

Referring now to FIG. 3, a method 300 for receiving a new electronic receipt with the e-receipt server 102 begins with block 302. In block 302, the e-receipt server 102 determines whether a new transaction has occurred. In some embodiments, the e-receipt server 102 may determine that a new transaction has occurred based on communications received from the point-of-sale terminal 122 or the mobile computing device 142, data entered into the point-of-sale terminal 122 or the mobile computing device 142 by a user, and/or the like. For example, the e-receipt server 102 may determine that the user has purchased a new product or service at the point-of-sale terminal 122. If the e-receipt server 102 determines that a new transaction has occurred, the method 300 advances to block 304.

In block 304, data corresponding to the new transaction is received by the e-receipt server 102. In some embodiments, the e-receipt server 102 receives the transaction data from the point-of-sale terminal 122 over the network 180. In other embodiments, the mobile computing device 142 is used as a proxy device between the point-of-sale terminal 122 and the e-receipt server 102. In such embodiments, the mobile computing device 142 first receives the transaction data from the point-of-sale terminal 122 using a contactless communication mechanism such as, for example, the NFC circuitry 154. Upon receipt, the mobile computing device 142 forwards (i.e., transmits) the transaction data to the e-receipt server 102 over the network 180. In some embodiments, the data and/or one or more of the communications between the e-receipt server 102, the point-of-sale terminal 122, and the mobile computing device 142 may be encrypted using one or more encryption keys stored in a secure storage on each device.

Alternatively, in some embodiments, the user may generate the e-receipt manually by entering data from a physical receipt of purchased product to an e-receipt template or specially-designed web interface, which may be accessed on the mobile computing device 142 and/or the computing device 162. In such embodiments, the manually-entered e-receipt may be marked or otherwise flagged as a self-generated e-receipt. The user may establish policy for in the user policies table 212 for the handling and/or labeling of such self-generated e-receipts. That is, such self-generated e-receipts may be handled in a manner different from the automated e-receipts for business or tax purposes and can be tracked accordingly.

The transaction data received by the e-receipt server 102 may be embodied as an electronic receipt including information associated with the transaction. As discussed above, a transaction may include a purchase transaction (i.e., the purchase of goods or services) a return transaction (i.e., the return or cancellation of goods or services), a prescription refill transaction (i.e., the refill of an prescription), and any other type of transaction that may be documented for historical preservation and/or record keeping. Additionally, the information associated with the transaction may describe one or more aspects or details of the transaction. For example, an electronic receipt may include information corresponding to the date that a product or service was purchased, the description of the product or service purchased, the price of the product or service, the name of the merchant, the location from which the product or service was purchased, the technical specifications of the product or service, the warranty information associated with the product or service, the return policy of the merchant, and any other information describing the details of the transaction.

In block 308, the e-receipt server 102 receives a unique user identifier from the point-of-sale terminal 122. In some embodiments, the electronic receipt also includes the user identifier, which as described above, uniquely identifies the particular user engaged in the transaction. For example, the electronic receipt may include the unique e-mail address and/or username assigned to the user. In use, the point-of-sale terminal 122 may obtain the unique e-mail address and/or username of the user during the transaction. The unique e-mail address and/or username of the user may be obtained via data entered into the point-of-sale terminal 122 (i.e., manual keyboard entry, voice recognition, optical recognition, entry on a touch screen device, biometric authentication, etc.). Regardless of the manner in which the unique e-mail address and/or username of the user is obtained, the point-of-sale terminal 122 may embed or otherwise include the unique e-mail address and/or username of the user in the transaction data, which is received by the e-receipt server 102 over the network 180.

In block 310, the electronic receipt, additionally or alternatively, may include additional forms of content associated with the transaction or the product purchased during the transaction. For example, the electronic receipt may also include an image of the products or services purchased, recall information associated with the products or services purchased, an electronic version (i.e., a Portable Document Format (PDF) file, an e-book, a web page, etc.) of a user's manual, audio files, video files, and any other form of content describing an additional aspect of the product or service or the transaction itself. Of course, the electronic receipt may also include interactive forms of content associated with the transaction and/or the product purchased during the transaction. For example, the electronic receipt may include an interactive troubleshooting guide, an interactive survey, and any other suitable form of interactive content for acting with the user regarding the transaction product purchased during the transaction.

In use, the point-of-sale terminal 122 may embed or otherwise include the additional content in the transaction data, which is received by the e-receipt server 102. It should be appreciated that although the point-of-sale terminal 122 embeds or otherwise includes the additional content in the transaction data in the illustrative embodiment, the e-receipt server 102 may retrieve the additional content from a location identified by one or more links, pointers, file paths, and/or destination addresses embedded in the transaction data by the point-of-sale terminal 122 in other embodiments. For example, the e-receipt server 102 may use the links, pointers, file paths, and/or destination addresses embedded in the transaction data to access the additional content from an internal data storage device (i.e., the data storage device 112), an external storage device connected to a peripheral port (i.e., a Universal Serial Bus (USB) storage device), and/or one or more remote computing devices and/or storage devices over the network 180. Additionally, it should be appreciated that although the transaction data in the illustrative embodiment is described as separately including the electronic receipt, the unique user identifier, and the additional content, the transaction data may be embodied as the electronic receipt in other embodiments. In such embodiments, the electronic receipt may include the information associated with the transaction, the unique user identifier, and the additional content.

In block 312, upon receiving the transaction data from the point-of-sale terminal 122, the e-receipt server 102 parses the electronic receipt to obtain the information describing one or more aspects or details of the transaction or the purchased product. For example, as discussed above, the electronic receipt in sonic embodiments may comprise an Extensible Markup Language (XML) document having one or more XML elements describing the information associated with a transaction. In such embodiments, e-receipt server 102 may parse the electronic receipt using an XML parser to extract the information. Once the information describing the one or more aspects or details of the transaction have been extracted from the electronic receipt, the method 300 advances to block 314.

In block 314, the e-receipt server 102 categorizes and/or organizes the electronic receipt as a function of any number of predefined or reference categories. In some embodiments, the e-receipt server 102 categorizes and/or organizes the electronic receipt according to the type of transaction. For example, in embodiments wherein the electronic receipt corresponds to a transaction for a monetary donation to a charity, the e-receipt server 102 may categorize the electronic receipt as a charitable contribution. In other embodiments, the e-receipt server 102 categorizes and/or organize the electronic receipt according to one or more user policies stored in, for example, the user policies table 212 of the electronic receipt database 206. To do so, the e-receipt server 102 may retrieve a user policy defining one or more rules for categorizing and/or organizing electronic receipts. The e-receipt server 102 may then apply the retrieved user policy to categorize and/or organize the electronic receipt.

In block 316 the e-receipt server 102 stores the information extracted from the electronic receipt in the electronic receipt database 206. In use, the e-receipt server 102 may store the extracted information, for example, in the electronic receipts table 208 of the electronic receipt database 206 as a function of the unique user identifier and one or more user policies. For example, the e-receipt server 102 may store the information extracted from the electronic receipt in the electronic receipts table 208 such that the information is associated with the unique user identifier. To do so, the e-receipt server 102 may use the user identifier as a unique key while storing the extracted information from the electronic receipt in the electronic receipts table 208 of the electronic receipt database 206. In other embodiments, the e-receipt server 102 may retrieve a user policy defining one or more rules storing information associated with electronic receipts. In such embodiments, the e-receipt server 102 may store the extracted information according to the retrieved user policy. For example, in embodiments in which the extracted information from the electronic receipt includes the user's credit card number, the e-receipt server 102 may redact a portion of or otherwise prevent the credit card number from being stored in the electronic receipt database 206.

In block 318, the e-receipt server 102, additionally or alternatively, notifies the user that the electronic receipt corresponding to the transaction has been received and stored in the electronic receipt database 206. To do so, the e-receipt server 102 may generate an alert and/or notification to be sent to the user via, for example, an e-mail message addressed to the user's personal e-mail message, a Short Message Service (SMS) text to a mobile computing device 142 (i.e., a mobile phone, a smart phone, a tablet computer, etc.) of the user, and any other suitable mechanism for alerting and/or notifying the user. Additionally, as described above, the e-receipt server 102 may generate an alert and/or notification according to one of more of the user policies stored in the user policies table 212.

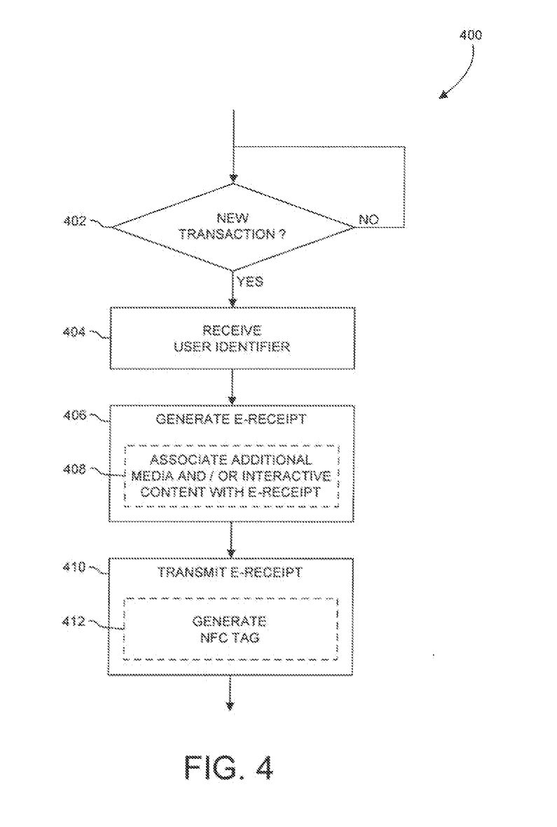

Referring now to FIG. 4, a method 400 for generating and transmitting a new electronic receipt with the point-of-sale terminal 122 begins with block 402. In block 402, the point-of-sale terminal 122 determines whether a new transaction has occurred. In some embodiments, point-of sale terminal 122 is directly involved in a transaction with the user. For example, the user may purchase a product in which the point-of-sale terminal 122 is used to complete the transaction. Additionally or alternatively, the point-of-sale terminal 122 may be indirectly involved in the transaction with the user. For example, in embodiments wherein the user purchases a product from an on-line retailer, the point-of-sale terminal 122 may be used to complete the transaction based on information received from another computing system (i.e., an on-line sales device, a web server, etc.) operated by the on-line retailer. If the point-of-sale terminal 122 determines that a new transaction has occurred, the method 400 advances to block 404.

In block 404, the point-of-sale terminal 122 receives the unique user identifier from the user involved in the transaction. As discussed above, the unique identifier of the user may include the unique e-mail address and/or username assigned to the user. To do so, the point-of-sale terminal 122 may obtain the unique e-mail address and/or username of the user via data entered into the point-of-sale terminal 122 (i.e., manual keyboard entry, voice recognition, optical recognition, entry on a touch screen device, biometric authentication, etc.). Once the point-of-sale terminal 122 receives the unique user identifier, the method 400 advances to block 406.

In block 406, the point-of-sale terminal 122 generates the electronic receipt corresponding to the transaction. To do so, the point-of-sale terminal 122 may collect information describing one or more aspects or details of the transaction or a product purchased during the transaction. For example, as described above, the information corresponding to the date that a product or service was purchased, the description of the product or service purchased, the price of the product or service, the name of the merchant, the location from which the product or service was purchased, the technical specifications of the product or service, the warranty information associated with the product or service, the return policy of the merchant, and any other information describing the details of the transaction may be collected by the point-of-sale terminal 122. Once the point-of-sale terminal 122 has collected the information describing the one or more aspects or details of the transaction or the product purchased during the transaction, the point-of-sale terminal 122 embeds or otherwise includes the information in the electronic receipt. To do so, the point-of-sale terminal 122 may encode the information in a data file according to a predefined or reference format (i.e., an XML document, a CSV file, a text tile, an encrypted data file, or any other format suitable to electronically embody information describing one or more aspects of a transaction).

In block 408, the point-of-sale terminal 122 may embed or otherwise include additional forms of content in the electronic receipt. As discussed above, the additional forms of content may be associated with the transaction or the product purchased during the transaction. It should be appreciated that although the point-of-sale terminal 122 embeds or otherwise includes the additional content in the electronic receipt in the illustrative embodiment, the point-of-sale terminal 122 in other embodiments, may embed or otherwise include one or more links, pointers, file paths, and/or destination addresses identifying a location from which the e-receipt server 102 may retrieve the additional content.

In block 410, the point-of-sale terminal 122 may transmit the generated electronic receipt to the e-receipt server 102 for storage and management. To do so, the point-of-sale device 122 may transmit the electronic receipt to the e-receipt server 102 over the network 180. In other embodiments, the mobile computing device 142 may be used as a proxy device between the point-of-sale terminal 122 and the e-receipt server 102. In such embodiments, the point-of-sale terminal 122 may generate, in block 412, an NFC tag comprising the electronic receipt. To do so, the point-of-sale terminal 122 may encode or otherwise convert the electronic receipt into the NFC tag. It should be understood that the NFC tag generated by the point-of-sale terminal 122 may be embodied as either a physical NFC tag or a “soft” NFC tag on the point-of-sale terminal 122, either of which may be read by the NFC circuitry 154 of the mobile computing device 142. Additionally, as discussed above, the user may manually generate an e-receipt in some embodiments based on data from a physical receipt.

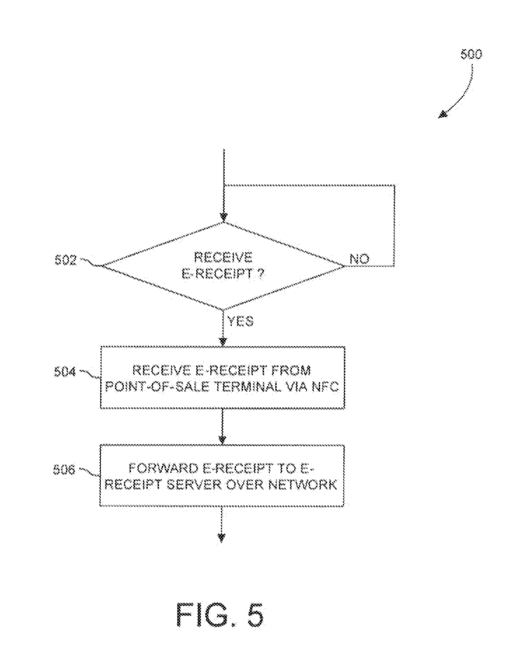

Referring now to FIG. 5, a method 500 for using the mobile computing device 142 as a proxy between the point-of-sale terminal 122 and the e-receipt server 102 begins with block 502. In block 502, the mobile computing device 142 determines whether a new electronic receipt has been received. In some embodiments, the mobile computing device 142 may determine that a new electronic receipt has been received based on communications received from the point-of-sale terminal 122, data entered into the point-of-sale terminal 122 by the user, and/or the like. If so, the method 500 advances to block 504.

In block 504, the mobile computing device 142 receives the electronic receipt from the point-of-sale terminal 122 using one or more NFC data exchanges 190. For example, the NFC circuitry 134 of the point-of-sale terminal 122 may transmit the electronic receipt to the NFC circuitry 154 of the mobile computing device 142 upon completion of the transaction. Upon receiving the electronic receipt from the point-of-sale device 122 using the one or more NFC data exchanges 190, the method 500 advances to block 506, in which the mobile computing device 142 forwards (i.e., transmits) the electronic receipt to the e-receipt server 102 over the network 180.

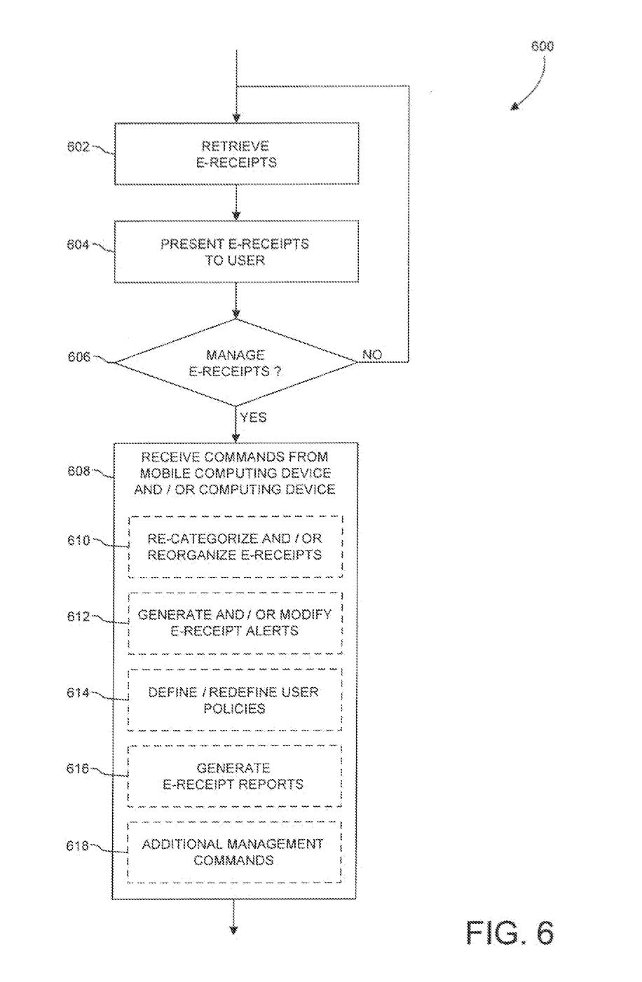

Referring now to FIG. 6, a method 600 for managing one or more electronic receipts stored on the e-receipt server 102 beings with block 602. In block 602, the e-receipt server 102 retrieves or more electronic receipts associated with the user. To do so, the e-receipt server 102 may obtain the user identifier associated with the user. As discussed above, electronic receipts for a particular user are stored in the electronic receipt database 206 such that each electronic receipt is associated with the unique user identifier assigned to that user. The e-receipt server 102 may obtain the user identifier associated with the user from communications received from a web browser or one or more applications executing on the mobile commuting device 142 and/or the computing device 162, data entered into the mobile computing device 142 and/or the computing device 162 by the user by the user, and/or the like. Once obtained, the e-receipt server 102 may use the unique user identifier to retrieve the electronic receipts associated with that particular user.

In block 604, the e-receipt server 102 may present the retrieved electronic receipts to the user. In some embodiments, the e-receipt server 102 generates one or more web pages including the retrieved electronic receipts. The one or more web pages may be transmitted to a web browser executing on the mobile computing device 142 and/or the computing device 162 to be displayed to the user. Additionally or alternatively, in some embodiments, the mobile computing device 142 and/or the computing device 162 may include one or more applications (i.e., proprietary applications, mobile applications, open source applications, etc.) for viewing and/or managing electronic receipts. In such embodiments, the e-receipt server 102 may transmit the retrieved electronic receipts the mobile computing device 142 and/or the computing device 162 in a format suitable to be displayed by the one or more applications when executed.

In block 606, the e-receipt server 102 may determine that the user desires to manage one or more electronic receipts stored in the electronic receipt database 206. In some embodiments, the e-receipt server 102 may determine that the user desires to manage one more of the electronic receipts based on communications received from the web browser and/or the one or more applications executing on the mobile computing device 142 and/or the computing device 162. If so, the method 600 advances to block 608.

In block 608, the e-receipt server may generate one or more web pages including management operations that the user may perform. The one or more web pages may be transmitted to the web browser executing on the mobile computing device 142 and/or the computing device 162 and displayed to the user. In use, the e-receipt server 102 may receive commands and/or data indicative of one or more management operations desired to be performed by the user from the web browsers executing on the mobile computing device 142 and/or the computing device 162. In embodiments wherein the mobile computing device 142 and/or the computing device 162 include one or more applications for managing electronic receipts, the e-receipt server 102 may receive commands and/or data indicative of one or more management operations desired to be performed by the user from the applications. In response to receiving the commands and/or data indicative of a management operation desired to be performed by the user, the e-receipt server 102 performs the corresponding management operations. For example, in block 610, the e-receipt server 102 may receive a command requesting that one or more electronic receipts be re-categorized and/or re-organized; in block 612, the e-receipt server may receive a command requesting that one or more alerts and/or notifications be generated or modified; and in block 614, a command may be received indicative of the user's desire to define or redefine one or more user policies. Additionally, in block 616, the e-receipt server 102 may receive a request to generate one or more reports corresponding to one or more of the electronic receipts in some embodiments. For example, the e-receipt server 102 may receive a command requesting that a report including all charitable contributions made during a predefined period of time and/or a user-defined period of time. It should be understood that although the management operations of blocks 610-616 may be performed by e-receipt server 102 in the illustrative embodiment, the e-receipt server 102 is capable of receiving requests for and performing additional management operations. For example, in block 618, the e-receipt server 102 may receive one or more additional management operations corresponding to one or more electronic receipts (e.g., any suitable management operation to facilitate managing and storing electronic receipts).

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

1-39. (canceled)

40. An apparatus comprising:
a communication module to receive transaction data from a point-of-sale terminal over a network, the transaction data corresponding to a product purchased during a purchase transaction;
an electronic receipt collection module to parse the transaction data to retrieve information describing an aspect of the purchased product or the purchase transaction; and
an electronic receipt database to store the information retrieved from the transaction data as an electronic receipt, the electronic receipt database comprises a plurality of electronic receipts, each of the plurality of electronic receipts associated with a unique identifier of a user.

41. The apparatus of claim 40, wherein the electronic receipt collection module further to store the electronic receipt as a function of the unique identifier of the user.

42. The apparatus of claim 40, further comprising:
an electronic receipt management module to retrieve the electronic receipt from the electronic receipt database as a function of the unique identifier of the user.

43. The apparatus of claim 42, wherein the electronic receipt management module to receive a command from a remote computing device requesting a management operation be performed on the electronic receipt, the electronic receipt management module to perform the requested management operation.

44. The apparatus of claim 40, wherein to receive transaction data from a point-of-sale terminal over a network comprises to receive transaction data from the point-of-sale terminal using a mobile computing device as a proxy, the mobile computing device to (i) receive the transaction data from the point-of-sale terminal using a contactless communication mechanism and (ii) forward the transaction data to the communication module over the network.

45. The apparatus of claim 44, wherein the contactless communication mechanism comprises near-filed communication (NFC) circuitry.

46. The apparatus of claim 40, further comprising:
a notification module to generate a notification in response to the electronic receipt collection module storing the electronic receipt in the electronic receipt database.

47. The apparatus of claim 40, further comprising:
a notification module to (i) monitor the electronic receipt database and (ii) generate an alert as a function of a user-defined policy.

48. The apparatus of claim 40, further comprising:
a notification module to (i) monitor the electronic receipt database, (ii) determine whether the electronic receipt or a group of electronic receipts associated with the user matches a user-defined policy, and (iii) generate an alert in response to determining that the electronic receipt or the group of electronic receipts associated with the user matches the user-defined policy.

49. The apparatus of claim 48, wherein the user-defined policy comprises a rule setting a maximum threshold amount of money that the user may spend on a product or category of products, and wherein to generate an alert in response to determining that the electronic receipt or the group of electronic receipts associated with the user matches the user-defined policy comprises to generate an alert in response to determining that an aggregate amount spent in the electronic receipt or the group of electronic receipts associated with the user exceeds the maximum threshold amount of money.

50. The apparatus of claim 40, further comprising:
a notification module to (i) determine reminder data and a reminder date as a function of the information describing an aspect of the purchased product or the purchase transaction and (ii) generate an alert on the reminder date to notify the user of the reminder data.

51. At least one machine readable media comprising a plurality of instructions, which in response to execution by an electronic receipt server, cause the electronic receipt server to:
receive transaction data from a point-of-sale terminal over a network, the transaction data corresponds to a product purchased during a purchase transaction;
parse the transaction data to retrieve information describing an aspect of the purchased product or the purchase transaction; and
store the information retrieved from the transaction data as an electronic receipt in a database, the database comprises a plurality of electronic receipts, each of the plurality of electronic receipts associated with a unique identifier of a user.

52. The at least one machine readable media of claim 51, wherein to store the information retrieved from the transaction data as an electronic receipt in a database comprises to store the electronic receipt in the database as a function of the unique identifier of the user.

53. The at least one machine readable media of claim 51, wherein the plurality of instructions further cause the electronic receipt server to retrieve the electronic receipt from the database as a function of the unique identifier of the user.

54. The at least one machine readable media of claim 53, wherein the plurality of instructions further cause the electronic receipt server to:
receive a command from a remote computing device requesting a management operation be performed on the electronic receipt; and
perform the requested management operation.

55. The at least one machine readable media of claim 51, wherein to receive transaction data from a point-of-sale terminal over a network comprises to receive transaction data from the point-of-sale terminal using a mobile computing device as a proxy.

56. The at least one machine readable media of claim 51, wherein the plurality of instructions further cause the electronic receipt server to:
generate a notification in response to storage of the electronic receipt in the database;
monitor the plurality of electronic receipts stored in the database; and
generate an alert as a function of a user-defined policy.

57. A method comprising:
receiving, by an electronic receipt server, transaction data from a point-of-sale terminal over a network, the transaction data corresponding to a product purchased during a purchase transaction;
parsing, by an electronic receipt server, the transaction data to retrieve information describing an aspect of the purchased product or the purchase transaction; and
storing, by the electronic receipt server, the information retrieved from the transaction data as an electronic receipt in a database, the database comprises a plurality of electronic receipts, each of the plurality of electronic receipts associated with a unique identifier of a user.

58. The method of claim 57, further comprising retrieving, by the electronic receipt server, the electronic receipt from the database as a function of the unique identifier of the user.

59. The method of claim 58, further comprising:
receiving, by the electronic receipt server, a command from a remote computing device requesting a management operation be performed on the electronic receipt; and
performing, by the electronic receipt server, the requested management operation.
